(19) United States
(12) Patent Application Publication
(10) Pub. No.: US 2011/0062918 A1
(43) Pub. Date: Mar. 17, 2011

(54) Method and device for monitoring the operating state of a battery

(76) Inventors: Peter Prenninger, Graz (AT); Erich Ramschak, Hausmannstatten (AT); Robert Fischer, Graz (AT)

(21) Appl. No.: 12/736,344

(22) PCT Filed: Mar. 26, 2009
(86) PCT No.: PCT/EP2009/053594

§ 371 Date: Nov. 19, 2010

(30) Foreign Application Priority Data
Apr. 1, 2008 (AT) A 508/2008

(51) Int. Cl. H02J 7/00; G01N 27/416

(52) U.S. Cl. 320/134; 324/426

(57) ABSTRACT

In a method for monitoring the operating state of a battery, preferably a Ni metal hydride or a Li-ion battery, formed of consisting of one or several interconnected battery cells, during the charging and discharging of the battery a low-frequency alternating current signal or voltage signal is applied to the battery. The resulting voltage or current signal is measured and the operating state of the battery or its battery cells is determined from at least one change in the harmonic distortion content of the measured voltage or current signal.

The invention relates to a method and an apparatus for monitoring the operating state of a battery, preferably a Ni metal hydride or Li-ion battery, consisting of one or several interconnected battery cells. The term battery shall also be understood below to be a battery pack or stack of batteries consisting of several batteries connected in series or in parallel.

Rechargeable high-power batteries or accumulators are used in modern drive systems in combination with electric machines for storing braking energy and as a power source for the complete or partial electromotive drive of vehicles. These high-performance batteries are mostly Ni metal hydride or Li-ion batteries in different configurations. During the life of the batteries, their charging capacity and their charging and discharging characteristics deteriorate as a result of chemical transformation processes on the electrodes and also in the electrolytes. Furthermore, the charging and discharging characteristics close to complete charging and discharging are no longer linear because these processes are determined by diffusion and the diffusion resistances increase strongly close to complete charging and discharging. Ultimately, the charging and discharging processes thus also depend to a high extent on the thermal state of the batteries because the diffusion processes are highly temperature-dependent.

Prolonged operation of a battery under these extreme charging states or under operational (thermal) boundary conditions which lead to such marked non-linear operating characteristics usually cause pronounced damaging effects, which is why these extreme charging states (overloading and deep discharging) must be avoided.

In the current state of the art, every single battery or accumulator cell is contacted and is monitored by measuring means with respect to the adherence to specific voltage thresholds. This leads to a high amount of expenditure in connection with measuring technology and data processing in units with many individual cells connected in series, which thus has a negative influence on the price and reliability of the battery system.

Another possibility for avoiding such extreme states is that mathematical models are prepared and parameterized first which enable the calculation both of the charging state (State of Charge—SOC) and the ageing state (State of Health—SOH) of the battery. The problematic aspect is the continuous rise of a difference between real and calculated states when either the models are not precise enough or unexpected long-term effects occur that were not considered in the models.

A method is known from JP 2001/076752 A which describes a reproducible method for quality assurance during the production of batteries. This method is used for the early recognition of the influence of foreign materials for example in battery elements and optionally their precipitation during production. The test is applied prior to filling the electrolyte into a cell which consists of a positive and negative electrode and an interposed separator.

The physical measuring parameter is the distortion factor of an alternating current signal. A controlled signal is supplied to the intermediate electrode for the distortion factor measurement via the positive and negative electrode and the distortion of the signal is measured. Useful cells have a specific resistance value which changes when foreign material is in the separator. The cell is rated as defective when the signal exceeds a predeterminable threshold value.

It is known from EP 1 260 824 A1 to measure batteries, especially automotive lead batteries, with the help of electric impedance spectroscopy (=frequency-resolved complex resistance diagram), and to draw conclusions on the charging state (SOC) and wear and tear (SOH). In detail, individual components of an equivalent electric circuit are extracted from the frequency diagrams and the changes in their values (resistance, inductivity or capacitance) are evaluated. This method is based on complex resistance measurement. A similar evaluation method is known from EP 1 357 390 A1.

It is the object of the invention to provide a method and an apparatus for monitoring the operating state of a battery, e.g. a Ni metal hydride or Li-ion battery, with a lower amount of measuring effort, with both defects as well as critical operating states of the battery or individual battery cells being detected in order to enable the initiation of required countermeasures in due time for the protection of the battery.

This object is achieved in accordance with the invention in such a way that during the charging and discharging of the battery a low-frequency alternating current or alternating voltage signal is applied, the resulting voltage or current signal is measured and the operating state of the battery or its battery cells is determined from at least one change in the harmonic distortion content of the measured voltage or current signal. The state of the battery or state of the individual cells is thus not observed directly, but indirectly. For this purpose, the non-linearities of the charging and discharging transfer characteristics of batteries are utilized. Specifically, it is possible to draw conclusions on the operating state of the battery during the charging and discharging cycles of the battery by an analysis of the distortion factor of the signal (as defined as the ratio of fundamental oscillation to its harmonic fractions).

In practice, the charging and discharging in power sources for the electromotive operation of vehicles for example which are also used for storing braking energy are not a process that is strictly defined in a temporal respect. The power is simply taken from the battery that the vehicle requires at a given point in time, i.e. the diagnosis in accordance with the invention is applied in all possible operating modes, irrespective of whether charging or discharging occurs in a current-controlled or voltage-controlled manner.

The apparatus in accordance with the invention for performing the method is characterized in that the battery is arranged in a circuit which comprises a signal generator for superimposing a low-frequency alternating current or alternating voltage signal to the battery, and an evaluation device is provided with which it is possible to draw conclusions on the operating state of the battery from at least one change of the harmonic distortion content of the measured voltage or current signal.

### a) Battery Charging Process

In accordance with the invention, a preferably sinusoidal alternating voltage fraction is superimposed to the battery during the charging process of the battery (e.g. to its charging voltage), with the harmonic distortion content of the occurring alternating current signal being measured and its increase indicating the approaching end of the charging process of the battery.

The final charging voltage is to be recognized by applying a small sinusoidal alternating fraction to the charge voltage. As a result of non-linear behaviour of the battery or transient processes in the battery, a current is obtained whose frequency spectrum no longer corresponds to that of the applied signal. In addition to harmonic distortion (formation of harmonics), there are modulation effects about the fundamental frequency that can be evaluated. As a result of the thermal effects and ageing effects as mentioned above, the charge characteristics also change. The range with high non-linearities close to the end of the charging is therefore variable and can be observed continually with the described diagnostic technology and the charging range can be utilized optimally.

b) Battery discharging process

In accordance with the invention, a preferably sinusoidal alternating current fraction is superimposed to the battery during the discharging process of the battery (e.g. to its discharging current), with the harmonic distortion content of the occurring alternating voltage signal being measured and its increase indicating the approaching end of the discharging process of the battery.

This state is determined for each type of battery by a specific voltage level per battery cell which must not fall below this value. If the value nevertheless falls below this level, a pole reversal of cells may occur, leading to massive damage. The behaviour of the cell is highly non-linear between the predetermined minimum voltage per cell and the voltage 0 (threshold voltage to pole reversal). A low sinusoidal current signal applied to the discharge current leads to a distorted voltage signal. The frequency spectrum of the voltage signal again differs from the applied sinus signal. This distortion can also be observed in the case that several cells are connected in series and only one or a few cells are already operated in the critical range. The diagnostic technology in question is thus activated during each discharging process and continuously observes any non-linear fractions in the voltage response signal of the battery or a battery stack.

These characteristic values for charging and discharging can subsequently be used both for adjusting the operating strategy of the entire drive system, for drive diagnosis (On-Board Diagnosis—OBD) and workshop diagnosis.

The measured current and voltage signals can be evaluated during the charging and discharging process of the battery by a transformation of voltage and current in the time-frequency range or by a Fourier transformation.

In accordance with the invention, the impressed current or voltage signal can have at least one frequency f2, preferably several superimposed frequencies f1, f2, f3, in the range of 0.1 Hz to 1000 Hz, preferably in the range of 10 Hz.

The invention is now explained below in closer detail by reference to schematic illustrations and diagrams, wherein:

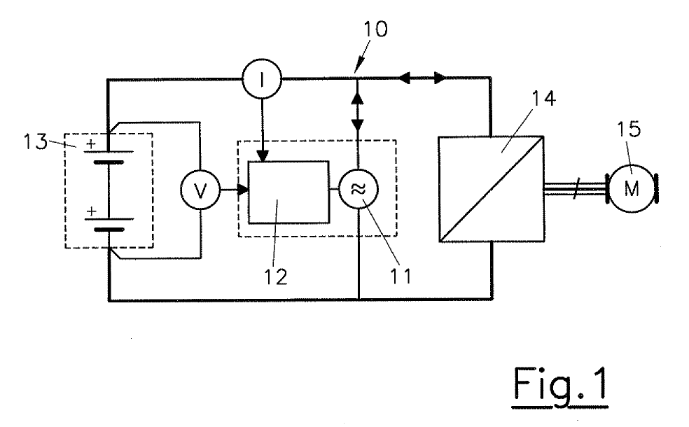

FIG. 1 shows a circuit diagram for checking the operating state of a battery during charging and discharging of the battery;

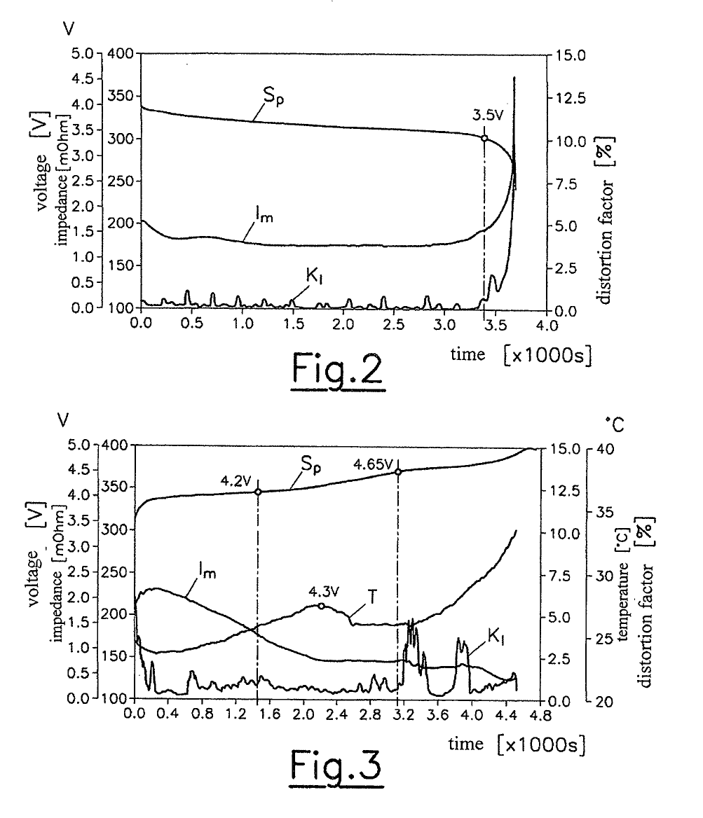

FIG. 2 shows the time diagram for a discharging process of a battery with impressed signal f1;

FIG. 3 shows the time diagram of a charging process of a battery with impressed signal f1;

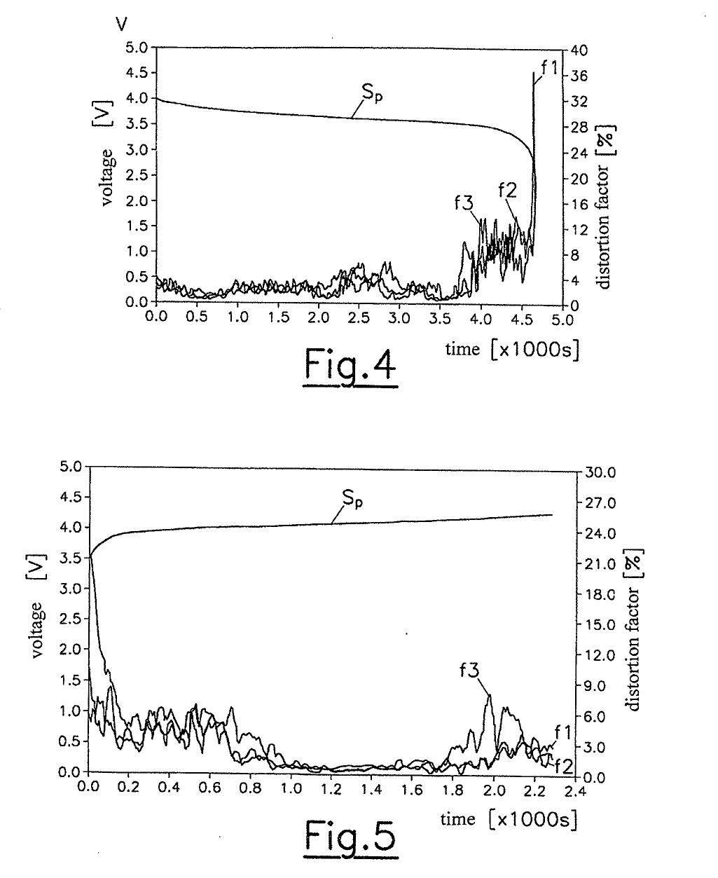

FIG. 4 shows the time diagram of a discharging process of a battery with an impressed sum signal of three different frequencies f1 to f3, and

FIG. 5 shows the time diagram of a charging process of a battery with an impressed sum signal of three difference frequencies f1 to f3.

The circuit diagram shown in FIG. 1 comprises a circuit 10 with a signal generator 11, with which a low alternating current is applied to a rechargeable battery 13 (e.g. a rechargeable lithium-ion battery with two cells). It is also possible to superimpose a low alternating voltage on the battery 13. The load current I and/or the battery voltage U is measured as a signal response and is supplied to an evaluation device 12. A signal analysis is performed in the evaluation device 12 and conclusions are drawn on the operating state of the battery 13 from at least one change in the harmonic distortion content of the measured voltage or current signal (e.g. an increase in the distortion factor). Reference numeral 15 designates an electric load, e.g. an electromotor, which is connected via an inverter (DC/DC) or a converter (DC/AC) 14 with the battery 13.

The following test results were obtained from a lithium-ion battery with the following parameters: Capacity 800 mAh, final charging voltage 4.2 V (+/−50 mV), typical voltage 3.6 V, final discharging voltage 2.4 V (+/−, 50 mV), maximum temperature during charging 40° C., maximum temperature during discharging 60° C.

FIG. 2 shows a discharging process with a sinus signal applied to the discharging current. An increase in the distortion factor by approx. 10% from a voltage Sₚ von 3.5 V can be seen from the diagram. For comparison reasons, the impedance Iₘ was measured in the test setup. Measurement of the impedance is not necessary for the method in accordance with the invention however. It can be seen that the curve of the distortion factor Kₗ correlates with the curve of the impedance Iₘ.

FIG. 3 shows the time diagram of a charging test which was performed until the destruction of the battery. A rise in the distortion factor Kₗ by 5% can be seen from a battery voltage Sₚ of 4.65 V. The rise in the distortion factor correlates with the rise in the temperature T, which indicates damage to the battery.

FIGS. 4 and 5 show the time diagrams of a discharge (FIG. 4) and a charge (FIG. 5) of the battery, with three different frequencies f1 (0.7 Hz), f2 (5.6 Hz) and f3 (12.9 Hz) having been impressed. FIG. 4 shows an indication for frequency-dependent selectivity in such a way that higher frequencies respond earlier to critical changes in the battery. FIG. 5 also shows that the rise in the distortion factor varies at different frequencies f1 to f3. Depending on the type of monitored battery, it is thus possible to determine an optimal frequency or an optimal frequency band.

1.-8. (canceled)

9. A method for monitoring the operating state of a battery, consisting of one or several interconnected battery cells, comprising the steps of:
applying a low-frequency alternating current signal or alternating voltage signal during the charging and discharging of the battery,
measuring the resulting voltage signal or current signal, and
determining the operating state of the battery or said battery cells from at least one change in the harmonic distortion content of the measured voltage signal or current signal.

10. The method according to claim 9, wherein conclusions are drawn on a non-linear operating state at the end of the charging or discharging process of the battery from an increasing harmonic distortion content of the measured voltage or current signal.

11. The method according to claim 9, wherein during the charging and discharging process of the battery a sinusoidal alternating voltage signal is applied to the battery, with the harmonic distortion content of the obtained alternating current signal being measured and conclusions being drawn from its increase on the approaching end of the charging process of the battery.

12. The method according to claim 9, wherein during the charging and discharging process of the battery a sinusoidal alternating current signal is applied to the battery, with the harmonic distortion content of the obtained alternating voltage signal being measured and conclusions being drawn from its increase on the approaching end of the discharging process of the battery.

13. The method according to claim 9, wherein the measured current and voltage signals are evaluated during the charging and discharging process of the battery by a transformation of voltage and current signals into the time frequency domain or by a pure frequency transformation.

14. The method according to claim 9, wherein the charging voltage or charging current of the battery is superimposed with at least one low-frequency sinusoidal current or voltage Signal.

15. The method according to claim 9, wherein the superimposed current or voltage signal comprises at least one frequency f1, in the range of 0.1 Hz to 1000 Hz, preferably in the range of 10 Hz.

16. The method according to claim 15, wherein the impressed current or voltage signal comprises several superimposed frequencies f1, f2, f3.

17. The method according to claim 9, wherein the battery is a Ni metal hydride or Li-ion battery.

18. An apparatus for monitoring the operating state of a battery, consisting of one or several interconnected battery cells, wherein the battery is arranged in a circuit which comprises a signal generator for applying a low-frequency alternating current signal or alternating voltage signal to the battery, and wherein an evaluation device is provided for drawing conclusions on the operating state of the battery from at least one change of the harmonic distortion content of the measured voltage signal or current signal.
